(19) United States
(12) Patent Application Publication
(10) Pub. No.: US 2018/0071051 A1
(43) Pub. Date: Mar. 15, 2018

(54) POWDER MIXED GAS GENERATOR

(71) Applicant: NAKANISHI INC., Kanuma-shi, Tochigi (JP)

(72) Inventor: Shoichi Takamori, Kanuma-shi, Tochigi (JP)

(21) Appl. No.: 15/554,565

(22) PCT Filed: Mar. 2, 2016
(86) PCT No.: PCT/JP2016/056320

§ 371 Date: Aug. 30, 2017

(30) Foreign Application Priority Data
Mar. 6, 2015 (JP) 2015-044943

(51) Int. Cl. A61C 3/025

(52) U.S. Cl. CPC A61C 3/025; B65G 53/16

(57) ABSTRACT

A powder-mixed-gas generator (20) includes a chamber (42) for containing powder (47) (the chamber being constituted of a vessel body (23) and a lid (24)), a gas injector (25) located within the chamber (42) for injecting a gas (54), and a mixture-gas discharger (26) for discharging a mixture gas (55) in which the gas and the powder (47) is mixed to the outside. The gas injector (25) injects the gas (54), thereby forming a circulation stream (52) that circulates inside the space (53). The mixture-gas discharger (26) has a mixture-gas suction port (49) for receiving the mixture gas (55). The mixture-gas suction port (49) has an opening that faces a direction in which the circulation stream (52) flows.

### TECHNICAL FIELD

The present invention relates to a powder-mixed-gas generator that can supply a suitable amount of powder from a vessel storing the powder to the outside, and for example, relates to a powder-mixed-gas generator for supplying powder to a tooth-surface-cleaning handpiece.

### BACKGROUND ART

Recently, a medical practice for cleaning teeth by blowing powder (fine particles) onto the teeth has been performed. For this purpose, it is necessary to supply a suitable amount of tooth-surface-cleaning powder onto a tooth-surface-cleaning handpiece, and various apparatuses have been proposed (for example, Patent Document 1).

In the first embodiment of Patent Document 1, a powder container contains an insert in which a mixing chamber having a shape of a hole vertically penetrating the insert is provided. A nozzle is upwardly inserted into a lower part of the mixing chamber.

When a gas is blown out from the nozzle, a negative pressure is generated and surrounding powder is attracted. As a result, a mixture of the gas and the powder ascends in the mixing chamber, so that part of the mixture moves into the outlet and is discharged through a mixture pipe.

However, the structure of the part for generating the negative pressure is complicated, and there is a concern that the gap between the nozzle and the wall surface of the lower part of the mixing chamber is clogged up with the powder after a long period of use.

According to the structure in the second embodiment of Patent Document 1, there is no concern that the powder gets stuck in the gap since negative pressure is not used.

This is because, in the second embodiment of Patent Document 1, gas is injected from a nozzle at an end of a gas pipe for blowing up the powder, and part of the powder is discharged via a mixture pipe.

However, in the structure in the second embodiment of Patent Document 1, the discharge amount of the powder varies significantly.

This is because the nozzle is directed downward so that the powder pushed by the gas moves upward in the cylindrical powder vessel and falls after striking against a lid member. In the course of the movement, part of the powder moves into the outlet. Since there is no particular regularity in the movement of the powder, the amount of the powder entering the outlet varies, and therefore, usability is deteriorated.

Since the apparatus is used by a human being, it is necessary to stabilize the discharge amount of the powder for comfortable usage.

### BACKGROUND ART DOCUMENT(S)

### Patent Document(s)

Patent Document 1: JP 2013-150871 A

### SUMMARY OF THE INVENTION

### Problems to be Solved by the Invention

It is an object of the present invention to provide a powder-mixed-gas generator that can stabilize the discharge amount of the powder with less clogging.

### Solution to the Problems

According to a first concept of the present invention, there is provided a powder-mixed-gas generator capable of supplying a suitable amount of powder from a vessel storing the powder to outside,

the vessel including a chamber having a shape resembling a sphere as a whole having a bottom being a hemispherical surface and a ceiling being a curved surface, the powder-mixed-gas generator including a gas injector configured to inject a gas into the chamber, and a mixture-gas discharger configured to discharge the suitable amount of the powder together with the gas,

a distal part of the gas injector being bent to be parallel with the hemispherical surface and being elongated into the chamber so that the gas injected therefrom is directed to a bottom of the hemispherical surface or neighborhood thereof,

a mixture-gas suction port of the mixture-gas discharger being located above the stored powder and located at an intermediate position between the hemispherical surface and the curved surface, the mixture-gas suction port of the mixture-gas discharger being arranged along a wall of the chamber for receiving the powder flowing along the curved surface.

Preferably, the powder is a tooth-surface-cleaning powder.

According to a second concept of the present invention, there is provided a powder-mixed-gas generator capable of supplying a suitable amount of powder from a vessel storing the powder to outside, the generator including:

a chamber having a space for containing the powder;

a gas injector located within the chamber and configured to inject gas; and

a mixture-gas discharger configured to discharge a mixture gas in which the gas and the powder is mixed to outside,

the gas injector injecting the gas, thereby forming a circulation stream that circulates inside the space,

the mixture-gas discharger having a mixture-gas suction port for receiving the mixture gas,

the mixture-gas suction port having an opening that faces a direction in which the circulation stream flows.

Preferably, the space includes

a first region in which the circulation stream flows and

a second region in which the circulation stream does not flow,

the powder and the gas are mixed to form the mixture gas in the first region,

the powder that has not been included in the mixture gas is stored in the second region, and

when the powder is removed from the first region in response to discharge of the mixture gas, the powder in the second region is automatically supplied to the first region.

### Advantages of the Invention

The powder-mixed-gas generator includes a vessel having a chamber having a shape that resembles a sphere, a gas injector provided in the vessel, and a mixture-gas discharger provided in the vessel, and has a simple structure as a whole, which results in eliminating the concern of clogging.

Furthermore, since the distal part of the gas injector is in parallel with the hemispherical surface, the gas injected from the gas injector forms a circulation stream that circulates in the space inside the vessel and mixes the powder in contact with the circulation stream with the gas to form the mixture gas. In the space inside the vessel, a first region in which the circulation stream flows and a second region in which the circulation stream does not flow are formed. When part of the powder is removed from the first region by discharging through the mixture-gas discharger, the powder is automatically supplied from the second region to the first region.

Therefore, according to the present invention, there is provided a powder-mixed-gas generator that can stabilize the discharge amount of the powder with less clogging.

The powder is a tooth-surface-cleaning powder. The powder-mixed-gas generator can be used arbitrarily according to claim 1, whereas the use thereof is limited to cleaning for teeth surfaces according to claim 2.

Since the discharge amount of the powder is stabilized, there will be no concern of discomforting the operator.

Therefore, the present invention can promote the spread of powder-mixed-gas generators for cleaning of teeth surfaces.

Since the mixture-gas discharger in the powder-mixed-gas generator is provided with a mixture-gas suction port and the mixture-gas suction port is provided with an opening that faces a direction in which the circulation stream flows, the opening can receive the circulation stream that is made by the gas injector to circulate inside the space and the discharge amount of the powder can be stabilized.

The space in the chamber includes a first region in which the circulation stream flows and a second region in which the circulation stream does not flow, and when the powder is removed from the first region, the powder is automatically supplied from the second region to the first region. Accordingly, the discharge amount of the powder can be further stabilized.

### BRIEF DESCRIPTION OF THE DRAWINGS

FIG. 1 is a perspective view of a tooth-surface-cleaning apparatus.

FIG. 2 is a view for showing the appearance of a powder-mixed-gas generator according to an embodiment of the present invention.

FIG. 3 is a cross-sectional view of the powder-mixed-gas generator.

FIG. 4 is a view for explaining the shape of a chamber.

FIG. 5 is a view for explaining a relationship between a gas injector and a mixture-gas discharger.

FIG. 6 is a view taken along line 6 in FIG. 3.

FIG. 7 is a view taken along line 7 in FIG. 3.

FIG. 8 is a view for explaining an operation of the powder-mixed-gas generator.

FIG. 9 is a view for explaining the operation of the powder-mixed-gas generator.

### MODE FOR CARRYING OUT THE INVENTION

Hereinafter, with reference to the accompanying drawings, an embodiment of the present invention will be described.

### Embodiment

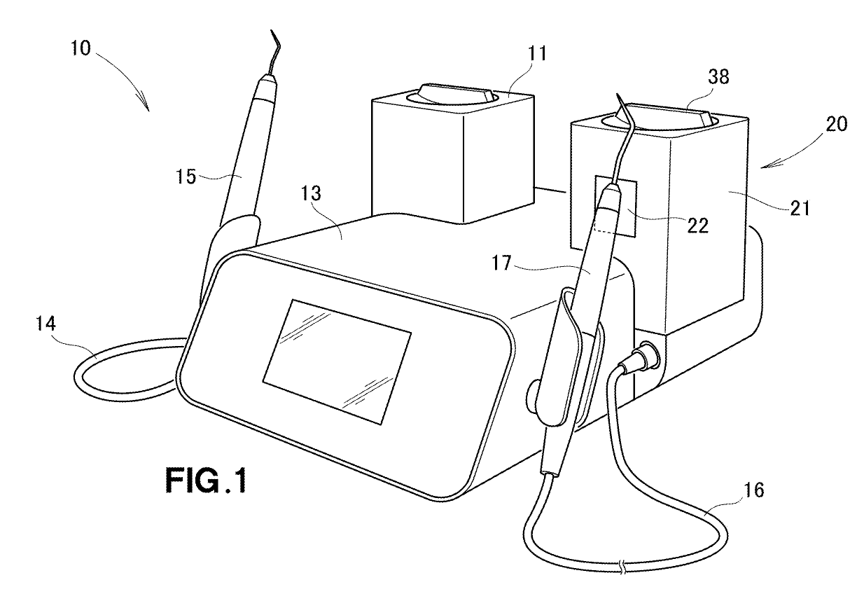

As shown in FIG. 1, a tooth-surface-cleaning apparatus 10 includes a box-type control unit 13 including a water tank 11 and a powder-mixed-gas generator 20; a first tube 14 extending from the control unit 13; a dental-scaling handpiece 15 connected to the distal end of the first tube 14; a second tube 16 extending from the control unit 13; and a tooth-surface-cleaning handpiece 17 connected to the distal end of the second tube 16.

Dental calculus is separated from the tooth by ultrasonic vibration of the dental-scaling handpiece 15 with water supply from the water tank 11, and is removed by the water.

The tooth-surface-cleaning handpiece 17 receives a supply of a mixture gas in which a powder is mixed with a gas from the powder-mixed-gas generator 20, and fulfills a role for injecting the mixture gas onto teeth surfaces.

The powder-mixed-gas generator 20 is contained in a box-type case 21. A transparent inspection window 22 is fitted to the front surface of the case 21 for confirming the residual quantity of the powder through the inspection window 22.

Hereinafter, the powder-mixed-gas generator 20 will be described in detail.

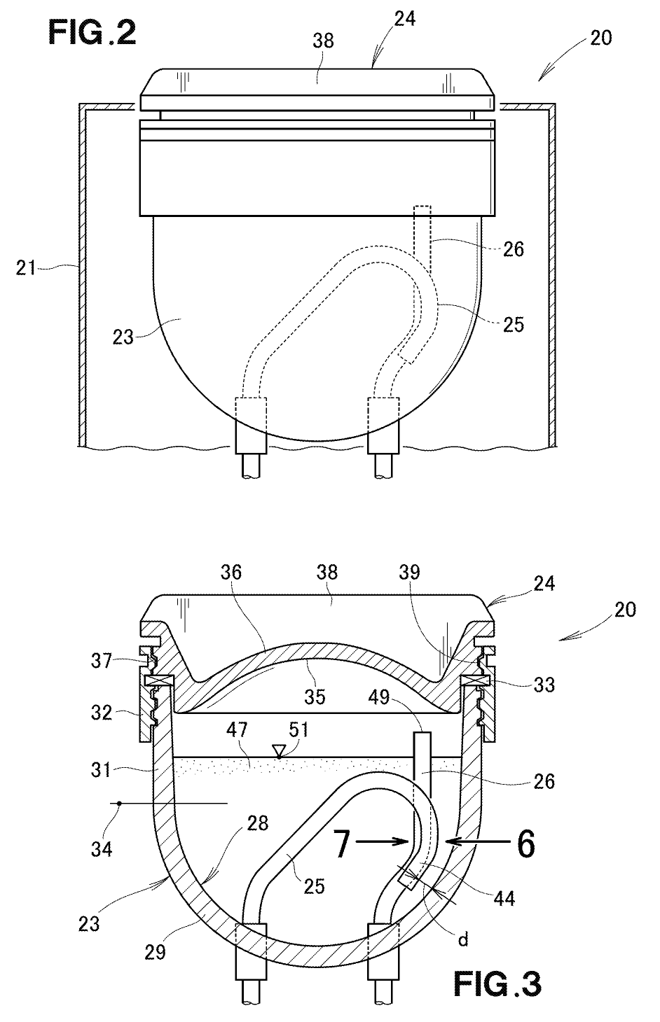

As shown in FIG. 2, the powder-mixed-gas generator 20 includes a vessel body 23 having a bottom that is a hemispherical shell, a lid 24 for closing a top opening of the vessel body 23, a gas injector 25 attached to the vessel body 23, and a mixture-gas discharger 26 attached to the vessel body 23. In other words, the vessel includes the vessel body 23 and the lid 24.

As shown in FIG. 3, the vessel body 23 includes a hemispherical shell section 29 of which the inner surface is a hemispherical surface 28, a cylindrical section 31 extending upward from the hemispherical shell section 29, a lid-fixing ring 32 mounted on the top of the cylindrical section 31, and a packing 33 fitted to the lid-fixing ring 32 and placed on the top surface of the cylindrical section 31. The hemispherical shell section 29 and the cylindrical section 31 constitute a single continuous unit although the curved line and the straight line are isolated by a line 34.

The lid 24 includes a lid body 36 of which the lower surface is a curved surface 35, a male thread 37 formed around the lid body 36, and a finger grip section 38 bridging over the lid body 36. By pinching and twisting the finger grip section 38, the male thread 37 is screwed into a female thread 39 provided at the lid-fixing ring 32 and is loosened from the female thread 39.

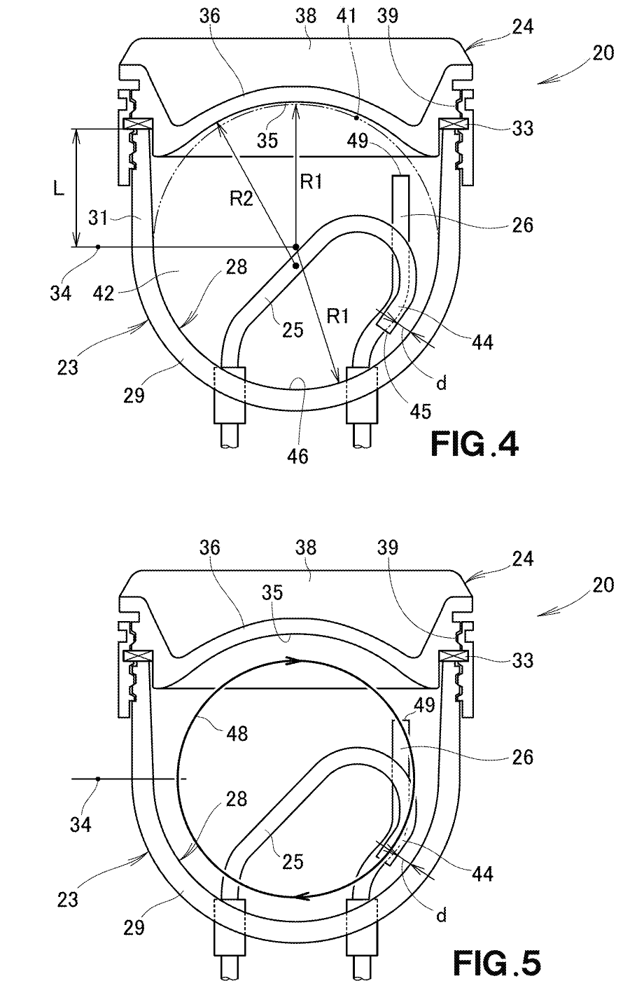

As shown in FIG. 4, let us assume that the radius of the hemispherical surface 28 is R1. The lid body 36 is arranged so as to be brought into contact with an imaginary circle 41 described with the radius R1 from outside. As a result, a chamber 42 within the vessel body 23 becomes to have a shape resembling the circle with the radius R1.

The cylindrical section 31 is essential for mounting the lid-fixing ring 32, but it is preferable that the axial length L thereof be small. In this embodiment, L is 0.8 times R1, but L can be selected from a range in which 0.6≦(L/R1)≦0.9. It is not preferable that L be greater than 0.9 times R1 since it will be difficult for the chamber 42 to have a shape resembling a circle. It is not preferable that L be less than 0.6 times R1 since it will be difficult to attach the lid-fixing ring 32.

The radius R2 of the curved surface 35 of the lid body 36 is decided to be greater than the radius R1. By deciding that R1<R2, the height of the lid 24 can be small, so that the powder-mixed-gas generator 20 can be downsized. However, since the chamber 42 should have a shape resembling a circle, it is recommended that R2 be selected from a range in which 1.1≦(R2/R1)≦1.3.

The gas injector 25 is, for example, a J-shaped tube of which the distal part 44 is arranged in parallel to the hemispherical surface 28 with a uniform distance “d” between the distal part 44 and the hemispherical surface 28. An injection opening 45 of the gas injector 25 is directed to (substantially the center of) the bottom 46 of the hemispherical surface 28. The distance “d” is selected from a range in which “d” is 0.5 to 1.5 times the outer diameter of the distal part 44.

If the distance “d” is less than 0.5 times the outer diameter of the distal part 44, there may be a risk that the gap between the hemispherical surface 28 and the distal part 44 is clogged up with powder 47. If the distance “d” is greater than 1.5 times the outer diameter of the distal part 44, it will be difficult to form a gas flow (denoted by symbol 48 in FIG. 5) along the hemispherical surface 28.

The powder 47 is, for example, a tooth-surface-cleaning powder made of calcium carbonate or sodium carbonate of which the average particle diameter is 50 to 80 micrometers.

The mixture-gas discharger 26 is arranged along the wall of the cylindrical section 31, so as to be capable of receiving the powder 47 flowing along the curved surface 35 of the lid body 36.

More specifically, as shown in FIG. 5, the mixture-gas discharger 26 is arranged, such that a mixture-gas suction port 49 of the mixture-gas discharger 26 overlaps (including substantially overlaps) an operational circle 48 that passes through the distal part 44 of the gas injector 25 and is parallel with the hemispherical surface 28. It is expected that pressurized gas flows along the operational circle 48.

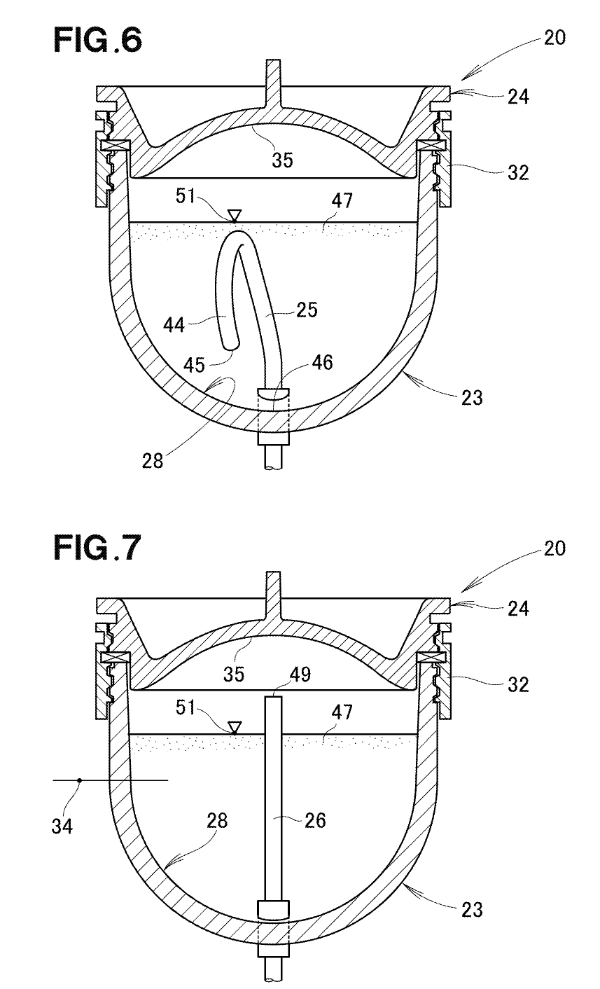

As shown in FIG. 6, the gas injector 25 is bent for avoiding interference with the mixture-gas discharger 26, but the injection opening 45 of the gas injector 25 is directed to (substantially the center of) the bottom 46 of the hemispherical surface 28.

As shown in FIG. 7, the mixture-gas discharger 26 is upwardly elongated to an intermediate position between the hemispherical surface 28 (line 34) and the curved surface 35, and the distal end of the mixture-gas discharger 26 is always located above the upper-limit level 51 for the powder 47. This location of the distal end of the mixture-gas discharger 26 ensures that the stored powder 47 is prevented from directly entering the mixture-gas suction port 49.

The mixture-gas suction port 49 may be provided by cutting the tube obliquely to the axis of the tube, but is provided by cutting the tube perpendicularly with respect to the axis of the tube in this embodiment. In comparison with oblique cutting, this significantly facilitates the cutting process and can reduce the process cost.

Next, operation of the powder-mixed-gas generator 20 with the above-described structure will be described.

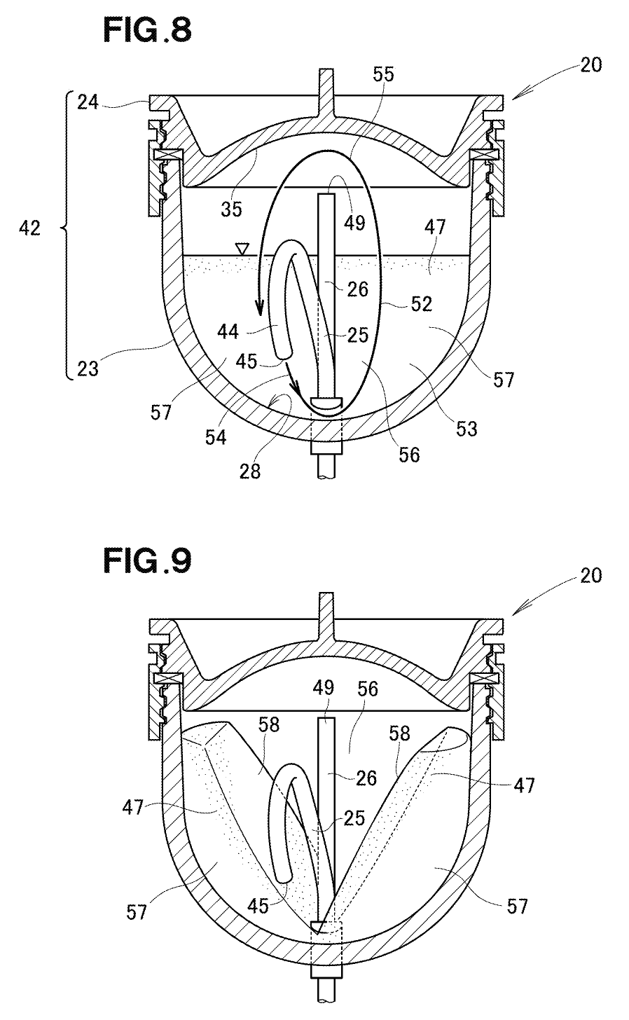

As shown in FIG. 8, the powder-mixed-gas generator 20 includes the chamber 42 having a space 53 for containing the powder 47 (the chamber 42 having the vessel body 23 and the lid 24), the gas injector 25 located within the chamber 42 for injecting gas 54, and the mixture-gas discharger 26 for discharging a mixture gas 55 in which the gas 54 and the powder 47 is mixed to the outside.

Here, the gas injector 25 injects the gas 54, thereby forming a circulation stream 52 that circulates inside the space 53. The mixture-gas discharger 26 is located in the path along which the circulation stream 52 flows.

In this structure, the gas injector 25 injects the gas 54 so that the circulation stream 52 flows along a vertical plane (a plane that is substantially perpendicular to a horizontal plane) passing the inside of the space 53.

In the above-mentioned powder-mixed-gas generator 20, the space 53 is considered to have a first region 56 in which the circulation stream 52 flows and second regions 57 in which the circulation stream 52 does not flow. In the first region 56, the powder 47 is in contact with the circulation stream 52, so that the powder 47 and the gas 54 are mixed to form the mixture gas 55.

In the second regions 57, the powder 47 that has not been included in the mixture gas 55 is stored. When the powder 47 is removed from the first region 56 in response to discharge of the mixture gas 55, the remaining powder 47 becomes to have a shape as shown in FIG. 9, and the powder 47 in the second regions 57 is automatically supplied to the first region 56.

More specifically, in the second regions 57, the powder 47 is stored to have planes 58 oblique to the above-mentioned vertical plane. When the powder 47 is removed from the first region 56 in response to discharge of the mixture gas 55, the powder 47 in the second regions 57 moves from the second regions 57 to the first region 56 along the planes 58 that incline with respect to the vertical plane.

As shown in FIG. 8, the above-mentioned chamber 42 includes the hemispherical surface 28 and the curved surface 35 that assist the flow of the circulation stream 52 circulating in the space 53. In this structure, the first region 56 utilizes the circulation stream 52 to return the mixture gas 55 to the gas injector 25 along the hemispherical surface 28 and the curved surface 35.

The above-mentioned gas injector 25 includes the injection opening 45 located near the side part of the hemispherical surface 28. The injection opening 45 injects the gas 54 toward the powder 47 contained in the space 53 of the chamber 42. Accordingly, in the first region 56, the gas 54 injected toward the powder 47 and the powder 47 are mixed to form the mixture gas 55. The mixture gas 55 circulates riding the circulation stream 52, and part of it is discharged. The mixture gas 55 that is not discharged is returned to the gas injector 25 along the hemispherical surface 28 and the curved surface 35 by means of the circulation stream 52.

The above-mentioned mixture-gas discharger 26 includes a mixture-gas suction port 49 for receiving the mixture gas 55. The mixture-gas suction port 49 includes an opening that faces the direction in which the circulation stream 52 flows (see also FIG. 5).

In the above-mentioned powder-mixed-gas generator 20, the powder 47 is stored in the space 53 as shown in FIG. 8 in the initial state before the gas 54 is injected from the gas injector 25. In other words, in the initial state, the powder 47 is contained substantially uniformly in the whole region corresponding to each of the first region 56 and the second regions 57.

Thereafter, in response to the start of injection of the gas 54 from the gas injector 25, part of the powder 47 in the first region 56 is mixed with the gas 54. At this time, the remaining powder 47 in the first region 56 is fed to the second regions 57.

Although the powder-mixed-gas generator 20 of this embodiment is preferable for the tooth-surface-cleaning apparatus 10, it can be used in a task of cleaning things other than teeth, for example, elements of a precision machine.

In addition, the structure of the present invention may be applied to a generating apparatus for generating a powder-mixed-gas for transferring powder in, for example, a plant for transferring powder.

### DESCRIPTION OF REFERENCE SYMBOLS

10: Tooth-Surface-Cleaning Apparatus

11: Water Tank

13: Control Unit

14: First Tube

15: Dental-Scaling Handpiece

16: Second Tube

17: Tooth-Surface-Cleaning Handpiece

20: Powder-Mixed-Gas Generator

21: Case

22: Inspection Window

23: Vessel Body of Vessel

24: Lid of Vessel

25: Gas Injector

26: Mixture-gas Discharger

28: Hemispherical Surface

29: Hemispherical Shell Section

31: Cylindrical Section

32: Lid-Fixing Ring

33: Packing

34: Line

35: Curved Surface

36: Lid Body

37: Male Thread

38: Finger Grip Section

39: Female Thread

41: Imaginary Circle

42: Chamber

44: Distal Part of Gas Injector

45: Injection Opening

46: Bottom of Hemispherical Surface

47: Powder

48: Operational Circle

49: Mixture-gas Suction Port

51: Upper-Limit Level for Stored Powder (Initial State)

53: Space

54: Gas

55: Mixture Gas

56: First Region

57: Second Region

58: Oblique Plane

1. A powder-mixed-gas generator capable of supplying a suitable amount of powder from a vessel storing the powder to outside,
the vessel including a chamber having a shape resembling a sphere as a whole having a bottom being a hemispherical surface and a ceiling being a curved surface,
the powder-mixed-gas generator comprising a gas injector configured to inject a gas into the chamber, and a mixture-gas discharger configured to discharge the suitable amount of the powder together with the gas,
a distal part of the gas injector being bent to be parallel with the hemispherical surface and being elongated into the chamber so that the gas injected therefrom is directed to a bottom of the hemispherical surface or neighborhood thereof,
a mixture-gas suction port of the mixture-gas discharger being located above the stored powder and located at an intermediate position between the hemispherical surface and the curved surface, the mixture-gas suction port of the mixture-gas discharger being arranged along a wall of the chamber for receiving the powder flowing along the curved surface.

2. The powder-mixed-gas generator according to claim 1, wherein the powder is a tooth-surface-cleaning powder.

3. A powder-mixed-gas generator capable of supplying a suitable amount of powder from a vessel storing the powder to outside, the generator comprising:
a chamber having a space for containing the powder;
a gas injector located within the chamber and configured to inject gas; and
a mixture-gas discharger configured to discharge a mixture gas in which the gas and the powder is mixed to outside,
the gas injector injecting the gas, thereby forming a circulation stream that circulates inside the space,
the mixture-gas discharger including a mixture-gas suction port for receiving the mixture gas, the mixture-gas suction port having an opening that faces a direction in which the circulation stream flows.

4. The powder-mixed-gas generator according to claim 3, wherein the space comprises a first region in which the circulation stream flows and a second region in which the circulation stream does not flow,
the powder and the gas are mixed to form the mixture gas in the first region,
the powder that has not been included in the mixture gas is stored in the second region, and
when the powder is removed from the first region in response to discharge of the mixture gas, the powder in the second region is automatically supplied to the first region.
